(19) United States
(12) Patent Application Publication
(10) Pub. No.: US 2005/0093690 A1
(43) Pub. Date: May 5, 2005

(54) Pressure-detection device and method

(76) Inventor: Joseph Miglionico, Euclid, OH (US)

Correspondence Address: Jonathan A. Platt;Renner, Otto, Boisselle & Sklar, LLP, Nineteenth Floor, 1621 Euclid Avenue, Cleveland, OH, 44115-2191, US

(21) Appl. No.: 10/939,677

(22) Filed: Sep. 13, 2004

Related U.S. Application Data
(60) Provisional application No. 60/501,986, filed on Sep. 11, 2003.

(51) Int. Cl. G08B 1/08

(52) U.S. Cl. 340/539.1; 340/665; 340/686.1; 340/572.1

(57) ABSTRACT

A pressure-sensing pad includes pressure-sensing structure for sensing the weight of objects placed upon it. The pressure-sensing structure includes a layer of force-sensing ink coupled to a pair of electrodes. The electrodes are connected to a power source, circuitry and a transmitter, all of which may be parts of a radio frequency identification (RFID) device. When weight is placed on or removed from the pressure-sensing structure, electrical characteristics of the force-sensing ink are altered, changing the electrical characteristics of the pressure-sensing structure. This change is detected by the circuitry, which sends a signal via the transmitter. A remote receiver may receive the signal, and initiate one or more of a variety of actions in response. The pressure-sensing pad may be placed on a force- or weight-receiving surface of an object, such as a chair or a shelf, to detect weight of people or objects thereupon.

This application claims priority from U.S. Provisional Application No. 60/501,986, filed Sep. 11, 2003, which is hereby incorporated by reference in its entirety.

### BACKGROUND OF THE INVENTION

1. Field of the Invention

This invention relates to devices and methods for detecting objects placed in certain areas or upon certain objects.

2. Description of the Related Art

Tracking of objects has been a long-standing problem in the history of humankind.

Radio frequency identification (RFID) tags and labels (collectively referred to herein as “devices”) are widely used to associate an object with an identification code. RFID devices generally have a combination of antennas and analog and/or digital electronics, which may include for example communications electronics, data memory, and control logic. For example, RFID tags are used in conjunction with security-locks in cars, for access control to buildings, and for tracking inventory and parcels. Some examples of RFID tags and labels appear in U.S. Pat. Nos. 6,107,920, 6,206,292, and 6,262,292.

RFID devices have been touted as a means of tracking objects. However, even though the cost of RFID devices has been steadily decreasing, those costs are not trivial. At present, RFID devices may be too costly for widespread one-time use. In addition, there are some objects, such as people, that actively resist having RFID devices applied to them for tracking purposes. In addition, privacy concerns have been raised regarding the presence of RFID devices in items purchased by consumers.

Accordingly, it will be appreciated that improved devices and methods for tracking items or objects would be desirable.

### SUMMARY OF THE INVENTION

According to an aspect of the invention, a sensing pad for sensing pressure or weight includes a force-sensitive ink layer between a pair of planar electrodes, and a transmitter for transmitting information regarding force or weight detected by the sensing pad.

According to another aspect of the invention, a system for determining occupancy of a cubicle or workspace includes a weight-sensing pad on a chair, wherein the sensing pad includes a transmitter for transmitting an RF signal regarding the weight detected by the sensing pad.

According to yet another aspect of the invention, a system for tracking items includes a sensing pad on a shelf or other surface upon which the items may be placed, wherein the sensing pad includes a transmitter for transmitting an RF signal regarding the weight detected by the sensing pad.

According to still another aspect of the invention, a system for tracking items includes a sensing pad coupled to a foot of a protrusion for supporting hanging items, wherein the sensing pad includes a transmitter for transmitting an RF signal regarding the weight detected by the sensing pad.

According to a further aspect of the invention, an inventory control system includes a pressure-sensitive sensing pad for sensing weight or force associated with placement of items in a given area, wherein the sensing pad include a transmitter for transmitting an RF signal to an inventory controller.

According to a still further aspect of the invention, a sensing pad for sensing pressure or weight includes a force-sensitive ink layer between a pair of planar electrodes, and an RF device coupled to the electrodes for transmitting information regarding force or weight detected by the sensing pad.

According to another aspect of the invention, a theft detection or recognition system includes a shelf or hanger rail having a sensing pad coupled thereto, wherein the sensing pad is configured to send an RF signal upon at least some instances of item removal from the shelf or hanger rail.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is an oblique view of a sensing system in accordance with the invention;

FIG. 2 is a cross-sectional view of a pressure-sensing structure of a sensing pad of the system of FIG. 1;

FIG. 3 is a plan view of a one embodiment of a sensing pad in accordance with the present invention;

FIG. 4 is an oblique view of a system in accordance with the present invention for monitoring a workspace or cubicle;

FIG. 5 is an oblique view of a system in accordance with the present invention for tracking items on a shelf; and

FIG. 6 is an oblique view of a system in accordance with the present invention for tracking items on a rail or protrusion.

### DETAILED DESCRIPTION

A pressure-sensing pad includes pressure-sensing structure for sensing the weight of objects placed upon it. The pressure-sensing structure includes a layer of force-sensing ink coupled to a pair of electrodes. The electrodes are connected to a power source, circuitry and a transmitter, all of which may be parts of a radio frequency identification (RFID) device. When weight is placed on or removed from the pressure-sensing structure, electrical characteristics of the force-sensing ink are altered, changing the electrical characteristics of the pressure-sensing structure. This change is detected by the circuitry, which sends a signal via the transmitter. A remote receiver may receive the signal, and initiate one or more of a variety of actions in response. The pressure-sensing pad may be placed on a force- or weight-receiving surface of an object, such as a chair or a shelf, to detect weight of people or objects thereupon.

In one specific embodiment, the pressure-sensing pad may be placed upon a chair, such as in an office or cubicle, to determine whether the office or cubicle is occupied. Responses to finding the chair unoccupied may include shutting off or otherwise altering operation of lights, environmental controls such as heating or air conditioning systems, or workstations.

In another embodiment, the pressure-sensing pad may be placed on a shelf where objects of merchandise are located. Tracking of objects on the shelf, and their removal from the shelf, may be used for inventory purposes (e.g., for determining when to re-order merchandise), and for detecting removal of a large number of items, which may be indicative of a theft attempt or other mischief.

In an additional merchandise-tracking embodiment, the pressure-sensing pad may be coupled to a hanger unit that receives suitable objects, such as hangtag objects. Removal of items from the hanger may be used for the inventory and theft-detection purposes described above.

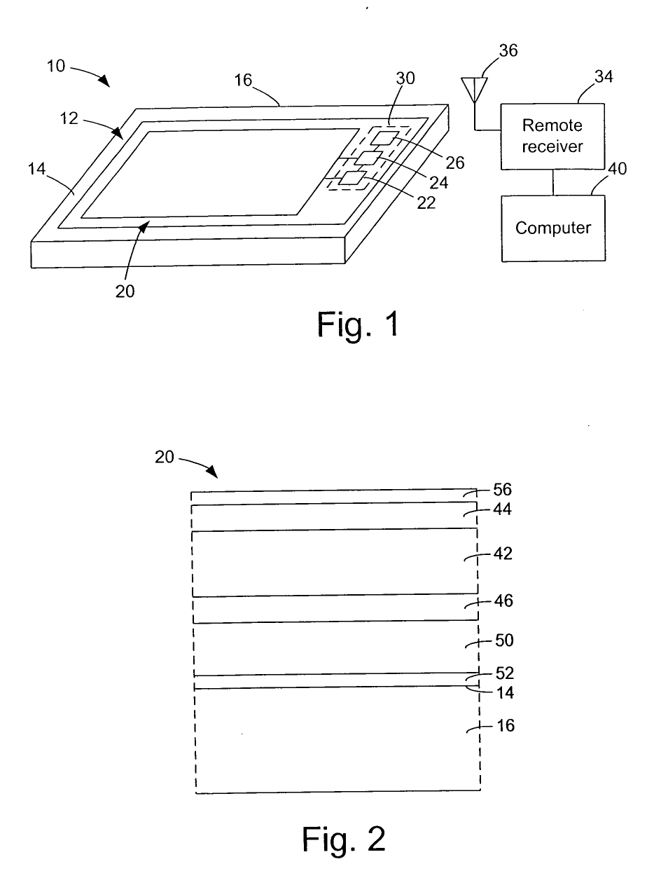

Referring to FIG. 1, a sensing system 10 includes a sensing pad 12 on a weight- or force-receiving surface 14 of force- or weight-receiving object 16. The sensing pad 12 includes a pressure-sensing structure 20 that changes electrical characteristics in response to a force thereupon. The pressure-sensing structure 20 is electrically coupled to a power source 22, circuitry 24, and a transmitter 26. The power source 22, the circuitry 24, and the transmitter 26 may all be parts of an RFID device 30. The power source 22, the circuitry 24, and the transmitter 26 may alternatively not be parts of an RFID device, with the transmitter 26 more broadly able to communicate through a wide variety of suitable RF communication forms and frequencies.

The power source 22, the circuitry 24, and transmitter 26 are used in conjunction with the pressure-sensing structure 20 to detect weight or another force on the surface of the sensing pad 12, and to transmit a signal to a remote receiver 34. The power source 22, for example a battery, is coupled to the structure 20 in a electrical circuit. The circuit is monitored by the circuitry 24. When weight (force) is added or removed from the sensing pad 12, the electrical characteristics of the structure 20 change. For example, as described in greater detail below, the resistance of the pressure-sensing structure 20 may change as a function of the pressure on the pad 12. This changes the electrical output, for example the current, through the circuit that the structure 20 is a part of. The circuitry 24 detects the change in the output of the circuit, and sends a signal via the transmitter 26. The signal from the transmitter 26, which may be a radio-frequency signal, is received by an antenna 36 that is coupled to the remote receiver 34. The remote receiver 34 is configured to interpret the signal. In addition, the remote receiver 34 may be coupled to a remote device 40, such as a computer, that may be configured to take a suitable action in response to the receipt of the signal form the sensing pad 12.

FIG. 2 shows one a cross-section of one possible configuration of the pressure-sensing structure 20 of the sensing pad 12. The electrically-active portion of the structure 20 includes a force-sensing ink layer 42 between a pair of planar electrode layers 44 and 46. The ink layer 42 may include an ink that changes its electrical characteristics under pressure. Examples of a suitable force-sensing inks are described in U.S. Pat. No. 5,541,570. More broadly, it will be appreciated that other sorts of suitable pressure-sensitive resistive layers may be used in place of the force-sensitive conductive ink described above.

The electrode layers 44 and 46 may be suitable layers of conductive material, for example suitable layers of copper or indium tin oxide. It will be appreciated that other metal oxides may be employed, such as indium oxide, titanium oxide, cadmium oxide, gallium indium oxide, niobium pentoxide, and tin oxide. In addition to a primary oxide, the electrodes may include a secondary metal oxide such as an oxide of cerium, titanium, zirconium, hafnium, and/or tantalum. A wide variety of conductive metals may also alternatively be used.

The electrode layers 44 and 46, and the force-sensing ink layer 42, may be supported on a suitable substrate 50. The substrate 50 may be made of any of a variety of suitable materials, for example, suitable flexible polymeric materials such as PET, polypropylene or other polyolefins, polycarbonate, or polysulfone.

The substrate 50 may have an adhesive layer 52 for attaching the sensing pad 12 to the surface 14 of the object 16. The adhesive layer 52 may include any of a variety of suitable adhesives, such as suitable pressure-sensitive adhesives, for coupling the sensing pad 12 to the object 16. The adhesive layer 52 may be deposited by any of a variety of suitable, well-known methods, such as printing or application by a roller, and may be covered with a protective layer, such as a paper peel layer, prior to use. It will be appreciated that alternatively the sensing pad 12 may be coupled or attached to the object 16 by other suitable means or methods. For example, heat-activated adhesives may be used to couple the substrate 50 to the object 16.

The structure 20 may also have a surface protection layer 56 to protect the other layers of the structure 20 from contamination or physical damage. The protection layer 56 may be made from any of a variety of suitable materials. One example of a potential protective layer material is a dielectric material such as SiO₂.

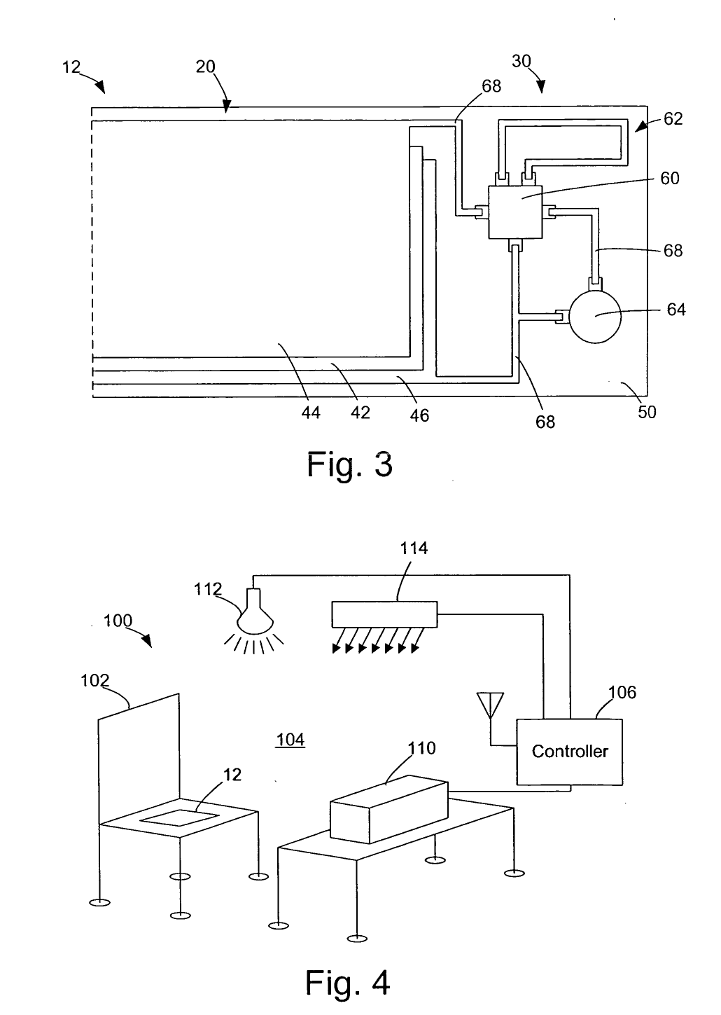

FIG. 3 shows one embodiment of a configuration of sensing pad 12, illustrating a configuration that may be made by a layered construction. The pad 12 includes a chip 60 that contains the circuitry 24 (FIG. 1) for operating the sensing pad 12. The chip 60 may be a suitable radio-frequency identification (RFID) chip or strap to be electrically coupled to an antenna 62, for use as the transmitter 26 (FIG. 1).

A battery 64 may also be part of the pad 12, acting as the power source 22 (FIG. 1). The battery 64 may be a traditional battery, such as flexible thin-film batteries sold by Cymbet Corporation of Elk Ridge, Minn., USA, which are described further in International Publication WO 01/73864. Alternatively, the battery 64 may be another sort of device for providing stored energy, such as a printed super capacitor.

Various conductive traces 68 connect the components of the sensing pad 12. The conductive traces 68 couple together the chip 60, the battery 64, and the electrode layers 44 and 46. In addition, some of the components may be formed in the same steps, and using the same methods and materials, as the conductive traces 68 are formed. For example, the electrode layers 44 and 46 and the antenna 62 may be formed of the same materials as the conductive traces 68.

Fabrication of the sensing pad 12 may be accomplished as follows. The chip 60 and the battery 64 may be placed at suitable positions on the substrate 50. Suitable adhesives may be used to hold the chip 60 and the battery 64 in place. Alternatively, the battery 64 may be formed by printing its various layers on the substrate 50.

A first (bottom) patterned conductive layer may then be formed on the substrate 50. The first patterned layer may be formed by selectively depositing indium tin oxide to form the bottom electrode 46 and the conductive traces 68 coupling the bottom electrode 46 to the chip 60 and the battery 64. In addition, the first patterned layer may include other of the conductive traces 68, such as the other conductive trace connecting the battery 64 and the chip 60. Also, the first patterned layer may include the antenna 62.

A variety of known methods may be used to make the first patterned layer. A layer of conductive material may be deposited, for example, by low temperature sputtering or direct current sputtering techniques (DC-sputtering or RF-DC sputtering), followed by selective removal of material.

Alternatively, the first patterned layer may be formed by electroplating. A patterned layer of conductive ink may be deposited on the substrate and contacts of the chip 60 and the battery 64 by known printing methods, such as screen printing, flexo printing, gravure printing, or inkjet printing. The substrate may then be placed in a suitable bath, with a suitable electroplating process used to form the first conductive pattern. For plating, the conductive ink pattern may have additional elements, used to facilitate uniformity in growth of the patterned conductive layer. These additional elements, and any material plated upon them, may be removed following the plating by suitable processes, such as etching.

The thickness of the conductive pattern material may be any of a wide variety of suitable thicknesses. For RFID antennas, thickness may be on the order of 18-30 microns for antennas used with 13.56 MHz systems, may be about 3 microns for antennas used with 900 MHz systems, and may be less than 3 microns for antennas used with 2.45 GHz systems. However, these thicknesses are merely examples, and it will be appreciated that conductive patterns with a wide variety of other thicknesses may be employed.

The force-sensing ink layer 42 may then be formed upon the bottom electrode 46 by suitable printing processes. Suitable such processes include those described above with regard to the printing of the conductive ink. Although for illustration purposes the force-sensing ink layer 42 and the electrode layers 44 and 46 are shown somewhat offset from one another in FIG. 3, it will be appreciated that the layers 42, 44, and 46 may all be substantially aligned with one another. The force-sensing ink layer 42 may be made to overlap the bottom electrode layer 46 somewhat, in order to provide protection against undesired direct contact between the electrode layers 44 and 46.

A second (top) patterned conductive layer may be formed. The second patterned layer includes the top electrode 44, and the conductive trace 68 connecting the top electrode 44 to a contact of the chip 60. The second patterned layer may also include conductive traces 68 or conductive structures, such as the antenna 62, not formed as part of the first patterned conductive layer. The second patterned conductive layer may be formed using methods similar to those used in formation of the first patterned conductive layer.

The protective layer 56 may then be formed. The protection layer 56 may be deposited, for instance, by printing or roller application.

The battery 64 may be configured so as to be de-activated until after the conductive patterns are fabricated, thus avoiding shorting during fabrication processes, such as during the plating operations described above. Suitable methods of de-activation depend on the battery type.

It will be appreciated that some or all of the operations described above may be performed in one or more roll-to-roll operations, for example utilizing a web of flexible substrate material. Suitable cutting operations may be used to separate individual sensing pads from the web after the sensing pad structures have been formed.

The layout of the sensing pad 12 shown in FIG. 3 is only one example of a possible configuration of the sensing pad 12. It will be appreciated that many other configurations are possible, including adding different components and/or combining multiple components into a single component.

It will be appreciated that the sensing pad 12 may transmit a variety of information. Such information may include an identifier associated with the sensing pad 12, allowing the information from various sensing pads 12 at various locations to be sorted out by the remote receiver 34 or an associated device. In addition, the sensing pad 12 may send any of a variety of signals regarding the weight or force on the sensing pad 12. This may range from a simple signal whenever weight or force is added or removed, to information regarding the amount of weight or force presently detected, and information regarding rates of change of weight or force.

What follows now are some examples of applications of the sensing pad 12. However, it will be appreciated that these are only a few examples of the wide variety of applications the sensing pad 12 described above may have.

FIG. 4 shows a system 100 with the sensing pad 12 on a chair 102 in a workspace or cubicle 104. The sensing pad 12 is placed on a seat of the chair to determine whether the chair is occupied, for example by being occupied by a worker assigned to the workspace or cubicle 104. The sensing pad 12 may transmit this information to a controller 106. The controller 106 may be configured to respond to a finding that the workspace or cubicle 104 is unoccupied (no substantial weight on the sensing pad 12), by reducing power usage in the workspace 104. This reduction in power usage may take any of a variety of forms, for example shutting off a computer or workstation 110, dimming or extinguishing lighting 112, and/or reducing operation of a heating, ventilation, and air conditioning (HVAC) system portion 114 serving the workspace or cubicle 104. The reducing in operation the HVAC system portion 114 may include changing a temperature setting, reducing blower speed, and/or shutting an HVAC outlet serving the workspace or cubicle 104.

The sensing pad 12 and/or the controller 106 may be configured to treat the chair 102 as unoccupied if the weight on the chair 102 is below a certain threshold level. This would avoid the system 100 treating as occupied a chair with an object such as a book on it.

It will be appreciated that the system 100 may include multiple such cubicles or workspaces, and may be configured to detect whether each of the workspaces is occupied, and to thereby allow control of environmental conditions and/or power usage individually for each of cubicles or workspaces.

Beside controlling environmental conditions and/or power usage, it will be appreciated that a system 100 such as the system described above may be used to gather information regarding individual or aggregate employee work habits, such as how often given workspaces or cubicles are unoccupied.

It will be appreciated that the system 100 may be augmented with additional sensing pads. For example, additional pads may be placed on the floor of the workspace, for instance to detect a pacing occupant of the workspace.

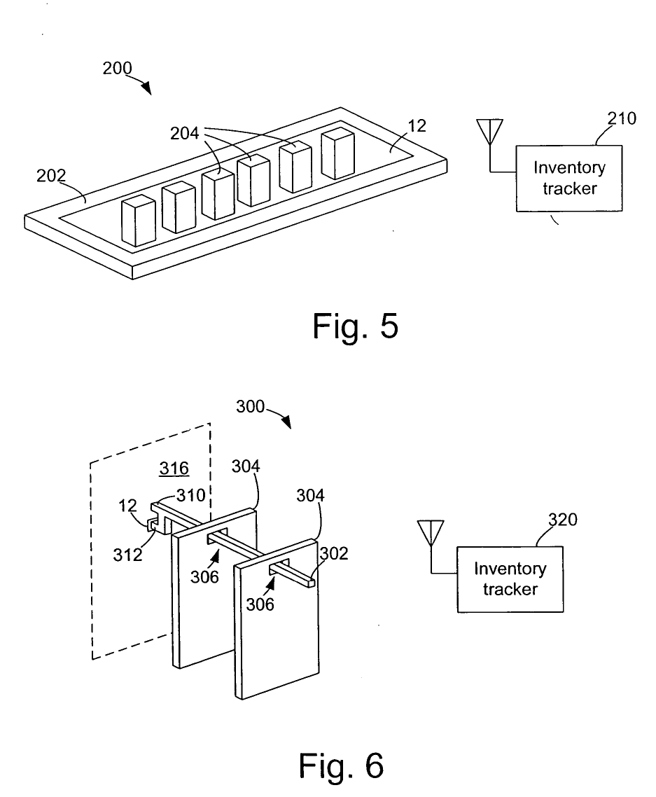

Turning now to FIG. 5, a system 200 is illustrated in which the sensing pad 12 is placed on a shelf 202. The shelf 202 is used for storage and/or presentation of a number of items 204. For instance, the items 204 may be salable merchandise items, with the shelf 202 being a store display shelf.

The sensing pad 12 transmits information to an inventory tracker 210 concerning the weight of the items 204 on the sensing pad 12. The sensing pad 12 may send periodic signals to the inventory tracker 210 regarding the weight of the items 204 on the sensing pad 12. Alternatively or in addition, the sensing pad 12 may be configured to send a signal to the inventory tracker 210 whenever one or more of the items 204 is placed on or removed from the shelf 202.

The inventory tracker 210 may be configured to take appropriate action with signals received from the sensing pad 12. For example, the inventory tracker 210 may be configured to reorder merchandise items when the supply of the items 204 reaches a certain level.

It will be appreciated that a variety of the sensing pads 12 may be utilized in a variety of different locations, and that the sensing pads may be placed in locations where different types of objects are supposed to be located. The sensing pads 12 may be placed on different shelves throughout a store, for example. The sensing pads 12 may be individually identifiable by the inventory tracker 210, allowing the system 200 to track a variety of items.

It will be appreciated that inventory tracking is only one of a variety of the uses that may be made of information from a shelf-mounted sensing pad. Such information may be provided in a real-time manner, and may allow in-depth analysis of shopper activities. For instance, the reaction to an in-store advertisement may be gauged with some accuracy by use of the system 200, with comparison of inventory movement during and immediately after the advertisement being measured. As another example, the system 200 may allow measurement of the amount of time that an item is removed and examined before being returned to the shelf 202 by a non-purchasing shopper. Further information may be obtained by placing one or more sensing pads 12 on the bottom of a shopping cart, allowing for a comparison of item-examination times for purchased items versus non-purchased items. The system 200 may also aid in identifying improper placement of items, such as when a shopper places an item on a shelf where it does not belong.

FIG. 6 shows a system 300 that tracks inventory from a protrusion or rail 302 for hanging items 304 thereupon. The items 304 may be small hangtag items, such as packages of razor blades, with holes 306 in them for allowing them to hang on the protrusion 302. The protrusion 302 may have notches (not shown) for receiving individual of the items 304. Alternatively, the protrusion 302 may have a smooth upper surface.

The protrusion has a pair of feet 310 and 312 for connecting to a display wall 316, such as a pegboard. One of the feet 312 may have a sensing pad 12 placed between the foot 312 and the wall 316. As the number of items 304 placed on the protrusion 302 changes, the force between the foot 312 and the wall 316. This change in force is detected by the sensing pad 12, and may be transmitted to an inventory tracker 320. The change in force, as items 304 are added to or removed from the protrusion 302, may be used by the inventory tracker 320 to keep track of inventory, and to perform the other operations described above with regard to the system 200.

It will be appreciated that the force between the foot 312 and the wall 316, detected by the sensing pad 12, is not a direct measure of the weight of the items 304 on the protrusion 302. Rather the force between the foot 312 and the wall 316 puts a torque on the protrusion 302 that balances the torque caused by the weight of the protrusion 302 and the weight of the items 304. It will be appreciated that the sensing pad 12 and/or the inventory tracker 320 may be configured to determine the number of items 304 added to or removed from the protrusion 302 from the change in the force between the foot 312 and the wall 316. The placement of the notches, if any, may facilitate determining when items are added or removed.

The system 300 may allow tracking of lighter items than may be accurately tracked by the system 200. The concentration of the force between the foot 312 and the wall 316 may allow for a stronger signal, more able to overcome noise, than the direct force of the weight of the items 304.

It will be appreciated that the configuration of the system 300 shown in FIG. 6 is but one example of a wide variety of possible configurations for measuring force due to objects or items. Many alternative configurations are possible. For instance, the sensing pad 12 may be placed in other locations to receive force due to objects or items. Other configurations of protrusions or racks, for example hooks, may have other force-receiving locations that would be suitable for placing the sensing pad 12. As another alternative, the sensing pad 12 may be placed in a location so as to receive force generated by multiple protrusions.

In addition to the functions described above, the system 300 may be utilized in a variety of ways as a theft detection or warning system. Some merchandise items are vulnerable to shoplifting because of their small size and resalablility, among other features. An example is razor blades, which are sold in easily concealable packets. The system 300 may be configured to provide an alert to a store employee when an unusual removal of the items 304 from the protrusion 302 is detected. One instance of an unusual removal may be the removal of a greater than usual number of the items 302, i.e., more than the usual number of items purchased by a single consumer. The system 300 may be configured to look for such a removal of an uncommonly large number of objects over a predetermined time interval. Once removal of an uncommonly large number of items is detected and an alert is transmitted to a store employee, such as a clerk or a guard, the employee may take appropriate action, such as increasing surveillance of customers and/or contacting law enforcement personnel.

Another example of unusual removal of objects is the removal of objects other than the topmost or forwardmost item on a protrusion (the item most visible to and presented to a customer shopping at a display). The system 300 may be configured to detect removal of items other than the topmost or forwardmost item 304 on the protrusion 302.

Yet another example of unusual removal of objects or items is yanking or pulling the items 304 off the protrusion 302, breaking part of the packaging of the items 304 rather than slipping them over the protrusion 302. This may be detected by the system 300 due to a transient rise in the force detected by the sensing pad 12, this transient rise corresponding to the yanking or pulling force used to tear the items 304 off the protrusion 302. This transient force rise may be followed by a reduction of force to a lower level than before the rise, the lower level corresponding to the fewer of the items 304 remaining on the protrusion 302. It will be appreciated that the transient force rise may also correspond to misplacement of heavy items on the protrusion 302, or to a pulling force being applied directly to the protrusion 302. These are events that also may warrant alerting of and intervention by a store employee.

It will be appreciated that at least some of the theft recognition and prevention utilizations of the system 300 may also be utilized with regard to the system 200.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1-3. (canceled)

4. A sensing pad comprising:
a sensing structure that includes:
a layer of force-sensing ink; and
a pair of electrodes coupled to the ink layer; and
a transmitter coupled to the electrodes, for transmitting a signal to a remote reader.

5. The sensing pad of claim 4, wherein the ink layer is between the electrodes.

6. The sensing pad of claim 5, wherein the electrodes are planar electrodes.

7. The sensing pad of claim 4, further comprising:
a substrate; and
an adhesive layer that adhesively couples the sensing structure to the substrate.

8. The sensing pad of claim 4, further comprising circuitry and a power source operatively coupled to the transmitter and the electrodes.

9. The sensing pad of claim 8, wherein the transmitter, the circuitry, and the power source are parts of a radio frequency identification (RFID) device.

10. The sensing pad of claim 4, as part of an item detection system.

11. The item detection system of claim 10, further comprising the reader for receiving signals from the sensing pad.

12. The item detection system of claim 10, wherein the item detection system includes multiple sensing pads.

13. The item detection system of claim 12, in combination with a shelf upon which the sensing pads are placed.

14. A method of detecting items at a specified location, comprising:
placing a sensing pad at the specified location; and
receiving a signal from the sensing pad when an event occurs regarding an item pressing against the sensing pad.

15. The method of claim 14,
wherein the placing includes placing a sensing pad that includes a force-sensing ink layer between a pair of electrodes; and
wherein the force-sensing ink layer changes electrical characteristics when the item is pressed against the sensing pad.

16. The method of claim 15,
wherein the sensing pad includes a transmitter operatively coupled to the electrodes; and
wherein the transmitter is configured to send the signal when the event occurs regarding an item pressing against the sensing pad.

17. The method of claim 16, wherein the sensing pad includes circuitry and a power source operatively coupled to the transmitter.

18. The method of claim 17,
wherein the transmitter, the circuitry, and the power source are parts of a radio frequency identification (RFID) device; and
wherein the signal is a radio frequency signal.

19. The method of claim 14, wherein the specified location includes a chair.

20. The method of claim 14, wherein the receiving includes receiving the signal at an inventory tracker.

21. The method of claim 20, wherein the specified location includes a shelf.

22. The method of claim 20, wherein the specified location includes a protrusion.

23. The method of claim 20, wherein the specified location includes a shopping cart.

24. The method of claim 14, wherein the placing includes adhesively attaching the sensing pad to an object.

25. The method of claim 14, wherein the receiving includes receiving a signal indicating placement of the item on the sensing pad.

26. The method of claim 14,
wherein the placing includes placing plural sensing pads at respective specified locations; and
wherein the receiving includes receiving signals from the plural sensing pads.

27. The method of claim 14, wherein the placing the sensing pad includes placing multiple sensing pads on a shelf.

28. The method of claim 27, wherein the receiving includes receiving a signal indicative of a total weight of items on the shelf.

29. The method of claim 27, wherein the receiving includes receiving a pad-specific signal, indicative at which of the pads the event occurs.

30. The method of claim 14, wherein the receiving includes receiving a signal indicative of a total number of the items on the sensing pad.

31. The method of claim 14, wherein the receiving includes receiving a signal indicative of a total weight of the items on the sensing pad.
